(19) United States
(12) Patent Application Publication
(10) Pub. No.: US 2015/0195708 A1
(43) Pub. Date: Jul. 9, 2015

(54) APPLICATION INSTALLATION SYSTEM AND METHOD

(71) Applicant: Google Inc., Mountain View, CA (US)

(72) Inventors: Jonathan W. Terleski, Mountain View, CA (US); Ujjwal Singh, Palo Alto, CA (US); Francis Ma, Toronto (CA)

(73) Assignee: Google Inc., Mountain View, CA (US)

(21) Appl. No.: 13/770,133

(22) Filed: Feb. 19, 2013

(51) Int. Cl. H04W 12/06

(52) U.S. Cl. CPC H04W 12/06

(57) ABSTRACT

A method and computing system for receiving a notification from a first website of a user signing into the first website. A determination is made concerning whether a compatible mobile application is available for the first website. If a compatible mobile application is available for the first website, a determination is made concerning whether the user has the compatible mobile application installed on a mobile device associated with the user. If the user does not have the compatible mobile application installed on the mobile device associated with the user, a determination is made concerning whether the compatible mobile application may be installed on the mobile device associated with the user.

### TECHNICAL FIELD

This disclosure relates to application installation and, more particularly, to the automated installation of applications on mobile devices.

### BACKGROUND

The Internet currently allows for the free exchange of ideas and information in a manner that was unimaginable only a couple of decades ago. One such use for the Internet is as a communication medium, whether it is via one-on-one exchanges or multi-party exchanges. For example, two individuals may exchange private emails with each other. Alternatively, multiple people may participate on a public website in which they may post entries that are published for multiple people to read. Examples of such websites may include but are not limited to product/service review sites and topical blogs.

As is known in the art, the internet includes a large quantity of websites that provide information to visitors. Examples of such websites may include but are not limited to review websites, social network websites, news websites, e-commerce websites, portal/search engine websites, entertainment websites, and/or auction websites. Often, the companies behind such websites generate mobile applications for installation on mobile devices that interface with these websites and provide the functionality of the same.

### SUMMARY OF DISCLOSURE

In one implementation, a computer-implemented method includes receiving a notification from a first website of a user signing into the first website. The user signed into the first website using credentials from a second website. A determination is made concerning whether a compatible mobile application is available for the first website. If a compatible mobile application is available for the first website, a determination is made concerning whether the user has the compatible mobile application installed on a mobile device associated with the user. If the user does not have the compatible mobile application installed on the mobile device associated with the user, a determination is made concerning whether the compatible mobile application may be installed on the mobile device associated with the user. If the compatible mobile application may be installed, the compatible mobile application is installed on the mobile device associated with the user, configuring the compatible mobile application to sign in using credential from the second website.

In another implementation, a computer-implemented method includes receiving a notification from a first website of a user signing into the first website. A determination is made concerning whether a compatible mobile application is available for the first website. If a compatible mobile application is available for the first website, a determination is made concerning whether the user has the compatible mobile application installed on a mobile device associated with the user. If the user does not have the compatible mobile application installed on the mobile device associated with the user, a determination is made concerning whether the compatible mobile application may be installed on the mobile device associated with the user.

One or more of the following features may be included. The user may have signed into the first website using credentials from a second website. The second website may be a social networking website. If the compatible mobile application may be installed, the compatible mobile application may be installed on the mobile device associated with the user.

Installing the mobile application on the mobile device associated with the user may include configuring the compatible mobile application to sign in using credentials from a second website. Determining if a compatible mobile application is available for the first website may include determining a device type for the mobile device associated with the user. Determining if a compatible mobile application is available for the first website may further include determining if the compatible mobile application is available for the device type. Determining if a compatible mobile application is available for the first website may include determining a user rating for the compatible mobile application. Determining if a compatible mobile application is available for the first website may further include if the user rating meets a predefined threshold, permitting the installation of the compatible mobile application on the mobile device associated with the user. Determining if a compatible mobile application is available for the first website may further include if the user rating does not meet a predefined threshold, prohibiting the installation of the compatible mobile application on the mobile device associated with the user.

In another implementation, a computing system includes at least one processor and at least one memory architecture coupled with the at least one processor, wherein the computing system is configured to perform operations including receiving a notification from a first website of a user signing into the first website. A determination is made concerning whether a compatible mobile application is available for the first website. If a compatible mobile application is available for the first website, a determination is made concerning whether the user has the compatible mobile application installed on a mobile device associated with the user. If the user does not have the compatible mobile application installed on the mobile device associated with the user, a determination is made concerning whether the compatible mobile application may be installed on the mobile device associated with the user.

One or more of the following features may be included. The user may have signed into the first website using credentials from a second website. The second website may be a social networking website. If the compatible mobile application may be installed, the compatible mobile application may be installed on the mobile device associated with the user.

Installing the mobile application on the mobile device associated with the user may include configuring the compatible mobile application to sign in using credentials from a second website. Determining if a compatible mobile application is available for the first website may include determining a device type for the mobile device associated with the user. Determining if a compatible mobile application is available for the first website may further include determining if the compatible mobile application is available for the device type. Determining if a compatible mobile application is available for the first website may include determining a user rating for the compatible mobile application. Determining if a compatible mobile application is available for the first website may further include if the user rating meets a predefined threshold, permitting the installation of the compatible mobile application on the mobile device associated with the user. Determining if a compatible mobile application is available for the first website may further include if the user rating does not meet a predefined threshold, prohibiting the installation of the compatible mobile application on the mobile device associated with the user.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes an application installation process according to an embodiment of the present disclosure;

FIG. 2 is a flowchart of the application installation process of FIG. 1 according to an embodiment of the present disclosure;

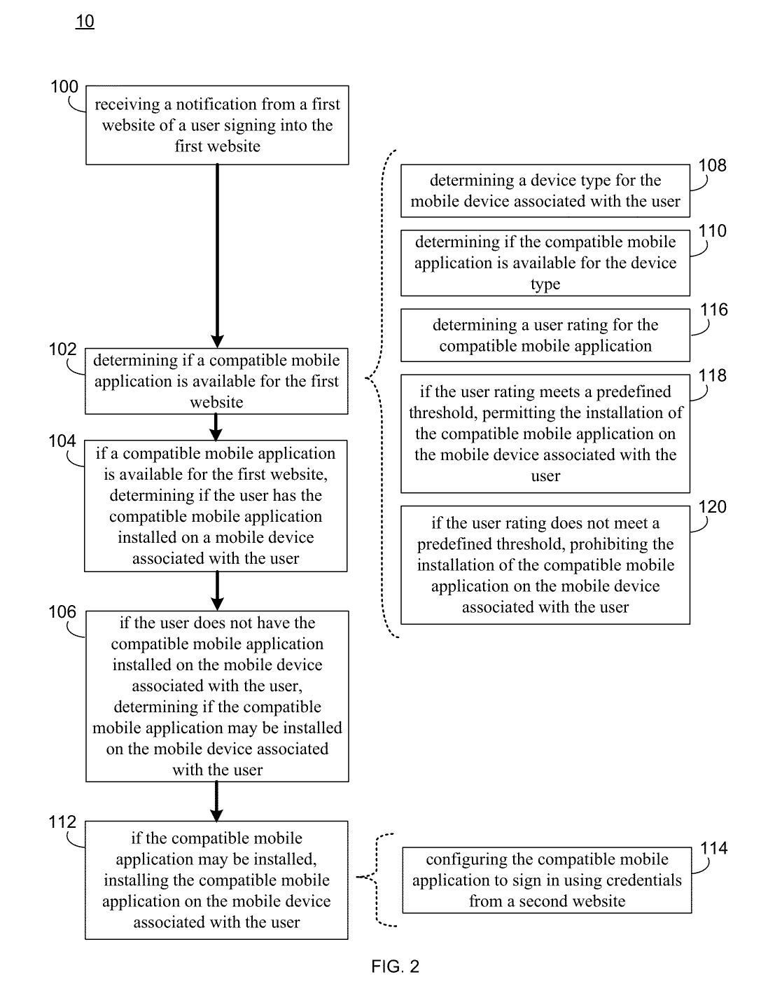

FIG. 3 is a diagrammatic view of a display screen rendered by the application installation process of FIG. 1 according to an embodiment of the present disclosure; and

FIG. 4 is a diagrammatic view of the computing device of FIG. 1 according to an embodiment of the present disclosure.

Like reference symbols in the various drawings indicate like elements.

### DETAILED DESCRIPTION OF THE PREFERRED EMBODIMENTS

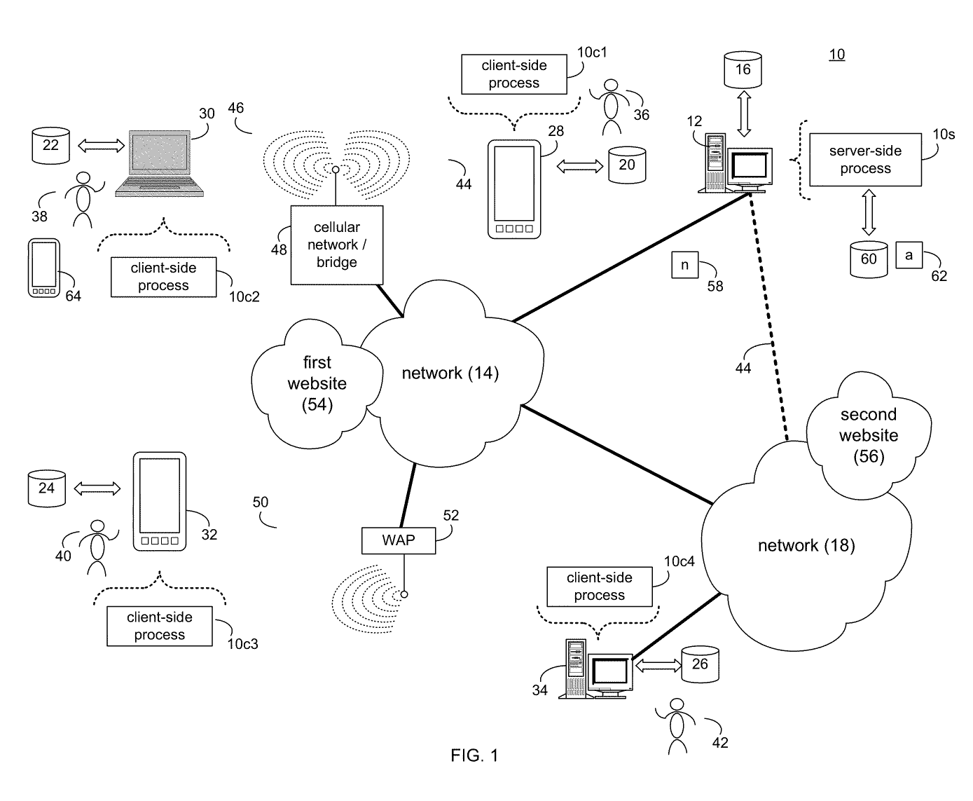

In FIGS. 1 & 2, there is shown application installation process 10. Application installation process 10 may be implemented as a server-side process, a client-side process, or a hybrid server-side/client-side process. For example, application installation process 10 may be implemented as a purely server-side process via server-side process 10s. Alternatively, application installation process 10 may be implemented as a purely client-side process via one or more of client-side process 10c1, client-side process 10c2, client-side process 10c3, and client-side process 10c4. Alternatively still, application installation process 10 may be implemented as a hybrid server-side/client-side process via server-side process 10s in combination with one or more of client-side process 10c1, client-side process 10c2, client-side process 10c3, and client-side process 10c4. Accordingly, application installation process 10 as used in this disclosure may include any combination of server-side process 10s, client-side process 10c1, client-side process 10c2, client-side process 10c3, and client-side process 10c4.

As will be discussed below in greater detail, application installation process 10 may receive 100 a notification from a first website of a user signing into the first website. Application installation process 10 may determine 102 if a compatible mobile application is available for the first website. If a compatible mobile application is available for the first website, application installation process 10 may determine 104 if the user has the compatible mobile application installed on a mobile device associated with the user. If the user does not have the compatible mobile application installed on the mobile device associated with the user, application installation process 10 may determine 106 if the compatible mobile application may be installed on the mobile device associated with the user.

Application installation process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a server computer, a series of server computers, a mini computer, a mainframe computer, or a dedicated network device.

The instruction sets and subroutines of server-side process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side processes 10c1, 10c2, 10c3, 10c4 may include but are not limited to a web browser, a game console user interface, or a specialized application (e.g., an application running on e.g., the Android™ platform or the iPhone™ platform). The instruction sets and subroutines of client-side processes 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, both stationary devices and mobile devices, such as data-enabled, cellular telephone 28, laptop computer 30, personal digital assistant 32, personal computer 34, a notebook computer (not shown), a server computer (not shown), a gaming console (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access application installation process 10 directly through network 14 or through secondary network 18. Further, application installation process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 44, 46 (respectively) established between data-enabled, cellular telephone 28, laptop computer 30 (respectively) and cellular network/bridge 48, which is shown directly coupled to network 14. Further, personal digital assistant 32 is shown wirelessly coupled to network 14 via wireless communication channel 50 established between personal digital assistant 32 and wireless access point (i.e., WAP) 52, which is shown directly coupled to network 14. Additionally, personal computer 34 is shown directly coupled to network 18 via a hardwired network connection.

WAP 52 may be, for example, an IEEE 802.11a, 802.11b, 802.11g, 802.11n, Wi-Fi, and/or Bluetooth device that is capable of establishing wireless communication channel 50 between personal digital assistant 32 and WAP 52. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

As discussed above, the internet may include a large quantity of websites that provide information to users. Examples of such websites may include but are not limited to social networking websites, restaurant review websites, entertainment websites, auction websites, and e-commerce websites. Assume that the internet includes first website 54 (e.g., a review website) that allows visitors of first website 54 to post and/or read reviews of various restaurants. For example, if user 36 visits a Mexican restaurant in San Jose, Calif., user 36 may post a review of that Mexican restaurant on first website 54. Further, if user 36 would like to visit a Thai restaurant in San Jose, Calif., user 36 may read the reviews of Thai restaurants located in the San Jose, Calif. area on first website 54.

However and as is often the case, websites may require a user to be a member of the website in order to post a review, as it may add credibility to the reviews. Accordingly, before user 36 may be able to write a review on first website 54 concerning the Mexican restaurant that he visited in San Jose, Calif., user 36 may be required to become a member of first website 54. Unfortunately, when a visitor of a website is informed that they are required to become a member of a website before being able to e.g., fully utilize the website, the user may often leave the website without e.g., posting the review.

In order to expedite the process of joining e.g., first website 54, user 36 may be given the option of logging into first website 54 using credentials associated with a second website (e.g., second website 56), wherein second website 56 may be a popular websites that user 36 may already be a member of Examples of second website 56 may include but are not limited to: social networking websites, email websites, portal/search engine websites, news websites and e-commerce websites. As is known in the art, the phrase social network may be used to refer to a group of technologies (e.g. web-based and mobile technologies) that allow for users (e.g., user 36) to engage in a quasi-real-time, interactive dialogue. Further, application installation process 10 may be included within, executed within, or a portion of second website 56 (e.g., a social network website).

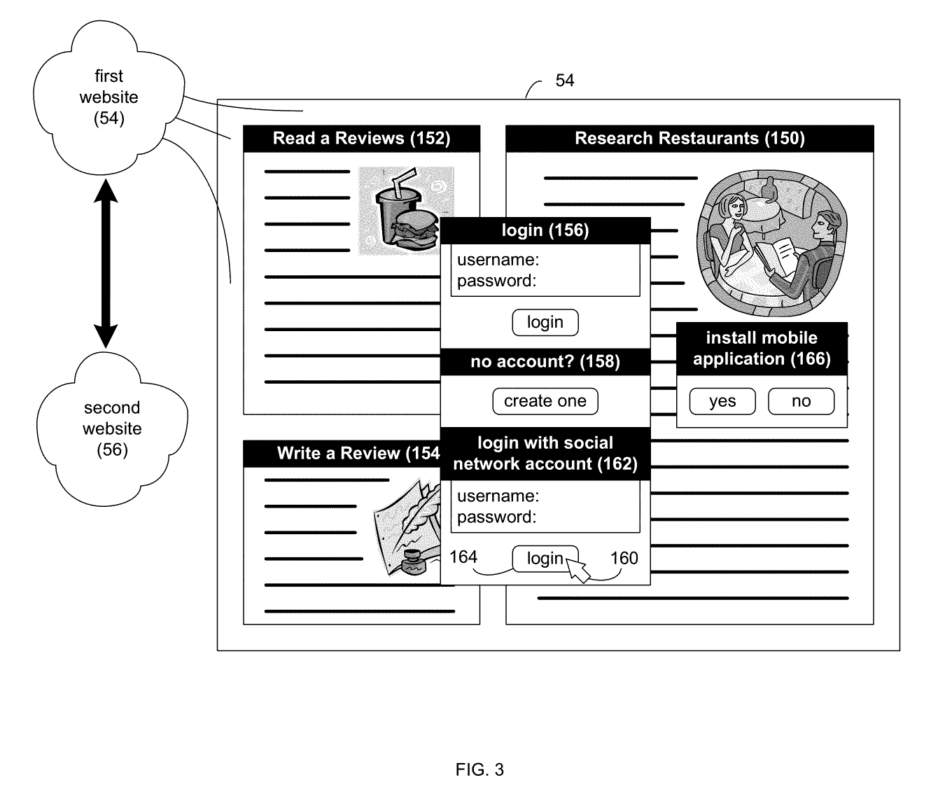

Referring also to FIG. 3, assume that user 38 visits first website 54 (e.g., the review website) using laptop computer 30 to leave a review concerning the above-described Mexican restaurant. Further, assume that user 38 is not a member of first website 54 and, therefore, cannot leave a review concerning the above-described Mexican restaurant.

First website 54 may include a plurality of portions that effectuate e.g. the reviewing of restaurants. For example, “Research Restaurants” portion 150 may be configured to enable user 38 to research restaurants. Specifically, “Research Restaurants” portion 150 may describe the various types of restaurants defined within first website 54 and the manner in which these restaurants are categorized. “Read a Review” portion 152 may allow user 38 to read reviews concerning various restaurants. Further, “Write a Review” portion 154 may be configured to allow user 38 to write a review concerning various restaurants.

Assume that when attempting to write a review concerning the above-described Mexican restaurant, user 38 is asked to log into first website 54 via login window 156. Login window 156 may include an area for user 38 to enter their username and password concerning first website 54. In the event that user 38 does not have a username and password for first website 54, login window 156 may include new user portion 158 that may allow user 38 to select the “create one” button using onscreen pointer 160 that is controllable by a pointing device (e.g. a mouse, not shown).

Additionally, login window 156 may include a portion that allows user 38 to log into first website 54 using their credentials from another website. Assume for illustrative purposes that user 38 is a member of second website 56 (e.g. a social networking website). Further, assume that login window 156 includes alternative login portion 162 that may allow user 38 to log into first website 54 using the credentials of the social network to which they belong (namely second website 56). Accordingly, alternative login portion 162 of login window 156 may allow user 38 to define their username and password for second website 56 (namely the social networking website). Once these login credentials are defined by user 38, user 38 may select “login” button 164 using onscreen pointer 160. Upon user 38 selecting “login” button 164, notification 58 may be generated (e.g. by first website 54) and provided to application installation process 10.

Notification 58 may identify user 38 by providing the username and password provided by user 38 to application installation process 10. Upon receiving 100 notification 58, application installation process 10 may determine whether or not user 38 is indeed a member of second website 56 by confirming that the username and password provided by user 38 were accurate/valid with respect to second website 56. For example, application installation process 10 may access informational datastore 60, which may be configured to identify the various users of second website 56 and the usernames/passwords associated with each.

As discussed above, the companies that are behind the above-described websites may generate mobile applications for installation on mobile devices, wherein these mobile applications may interface with the above-described websites and provide the functionality of the website to the user of the mobile application. Accordingly, such mobile applications may be generated for e.g., the above-referenced review websites (e.g., first website 64), social network websites (e.g., second website 56), news websites, e-commerce websites, portal/search engine websites, entertainment websites, and/or auction websites.

Informational datastore 60 may further be configured to be a software repository for storing and making available such mobile applications for e.g., review websites, social network websites, news websites, e-commerce websites, portal/search engine websites, entertainment websites, and/or auction websites. Accordingly, second website 56 (in combination with informational datastore 60) may perform the functionality of an application store/marketplace.

Informational datastore 60 may further be configured to identify the mobile device(s) owned by the various users identified in informational datastore 60 (e.g., the users of second website 56, including user 38). For example, upon users (e.g., user 38) registering with informational datastore 60 and/or second website 56, user 38 may be asked to provide information concerning the type(s) of mobile device(s) that they own. Alternatively, application installation process 10 may be configured to automatically determine the type(s) of mobile device(s) owned by the users of informational datastore 60 after e.g., the mobile device is registered with informational datastore 60. Assume that upon receiving notification 58, application installation process 10 may process notification 58 and query database 60 to determine 102 whether a compatible mobile application (e.g., mobile application 62) is available for first website 54.

When determining 102 if a compatible mobile application is available for first website 54, application installation process 10 may determine 108 a device type for the mobile device associated with e.g., user 38. As discussed above, informational datastore 60 may be configured to identify the mobile device(s) owned by the various users defined within informational datastore 60 (e.g., user 38). Accordingly, assume for illustrative purposes that informational datastore 60 identifies user 38 as owning the latest Android-powered smart phone (e.g., mobile device 64). Accordingly, application installation process 10 may query informational datastore 60 to determine 108 that user 38 is associated with mobile device 64 (e.g., the latest Android-powered smart phone).

Further, when determining 102 if a compatible mobile application is available for the first website 54, application installation process 10 may determine 110 if the compatible mobile application is available for the device type (e.g., mobile device 64) associated with e.g., user 38. Since notification 58 defines the particular website (e.g., first website 54) that user 38 is logging into and informational datastore 60 enabled application installation process 10 to determine 108 that user 38 is associated with mobile device 64 (e.g., the latest Android-powered smart phone), application installation process 10 may determine 110 if a compatible mobile application is available for this device type (e.g., a mobile device running the Android operating system). Assume for illustrative purposes that application installation process 10 determines 110 that mobile application 62 (designed for first website 54) is indeed compatible with e.g., a mobile device running the Android operating system, and is thus deemed to be a compatible mobile application.

If application installation process 10 determines 102 that a compatible mobile application (e.g., compatible mobile application 62) is available for first website 54, application installation process 10 may determine 104 if user 38 has compatible mobile application 62 installed on the mobile device (e.g., mobile device 64) associated with user 38. For example, informational datastore 60 may be configured to define the mobile applications installed on the various mobile devices associated with the users defined within informational datastore 60. Accordingly, application installation process 10 may query informational datastore 60 to determine whether compatible mobile application 62 is installed on mobile device 64. Alternatively, application installation process 10 may be configured to query mobile device 64 to determine whether compatible mobile application 62 is installed on mobile device 64.

If application installation process 10 determines 104 that e.g. user 38 does not have compatible mobile application 62 installed on the mobile device (e.g. mobile device 64) associated with user 38, application installation process 10 may determine 106 if compatible mobile application 62 may be installed on mobile device 64 associated with user 38. For example, application installation process 10 may render permission window 166 that requests permission from user 38 to install compatible mobile application 62 on mobile device 64, wherein user 38 may select (via on-screen pointer 160) either the “yes” button or “no” button. Alternatively, application installation process 10 may determine if user 38 previously opted-in to having compatible mobile applications automatically installed on their mobile device (when compatible mobile applications are available). Alternatively still, the compatible mobile application made be a paid application and the installation process may have user 38 log into first website 54 so that compatible mobile application 62 may be automatically installed on their mobile device.

Continuing with the above-stated example in which application installation process 10 renders permission window 166, if the compatible mobile application may be installed (e.g. user 38 selects the “yes” button using onscreen pointer 160), application installation process 10 may install 112 compatible mobile application 62 on mobile device 64 associated with user 38. As discussed above, user 38 visited first website 54 using laptop computer 30. Accordingly, the above-described process of communicating with user 38 to request permission to install compatible mobile application 62 was performed on laptop computer 30. Accordingly, when installing compatible mobile application 62 on mobile device 64, application installation process 10 may install compatible mobile application 62 in a manner that is unobtrusive to user 38. For example, since user 38 is currently using laptop 30 to access first website 54, user 38 is probably not currently using mobile device 64. However, application installation process 10 may perform the above-described installation 112 of compatible mobile application 62 onto mobile device 64 while mobile device 64 is not being used by user 38. Accordingly, when user 38 once again uses mobile device 64, compatible mobile application 62 may have already been installed 112 by application installation process 10.

When installing 112 compatible mobile application 62 on mobile device 64 associated with user 38, application installation process 10 may configure 114 compatible mobile application 62 to sign in (e.g. to first website 54) using the above-described credentials from second website 56. Accordingly, once installation 112 of compatible mobile application 62 has been completed by application installation process 10 and upon user 38 initiating use of mobile application 62, mobile application 62 may have been already configured 114 by application installation process 10 to sign into first website 54 using the credentials of second website 56, thus eliminating the need for user 38 to perform an initial configuration of compatible mobile application 62.

When determining 104 if a compatible mobile application is available for the first website 54, application installation process 10 may be configured to take into consideration the user ratings of the various mobile applications stored within informational datastore 60. Specifically, application installation process 10 may be less inclined to promote/install mobile applications that have low user ratings and more inclined to promote/install mobile applications that have high user ratings.

Accordingly, when determining 104 if a compatible mobile application (e.g. compatible mobile application 62) is available for first website 54, application installation process 10 may determine 116 a user rating for the compatible mobile application. Continuing with the example in which application installation process 10 determines 102 that a compatible mobile application (e.g., compatible mobile application 62) is available for first website 54, application installation process 10 may determine 116 a user rating for compatible mobile application 62.

Accordingly, if the user rating for compatible mobile application 62 meets a predefined threshold, application installation process 10 may permit 118 the installation of compatible mobile application 62 onto mobile device 64 associated with user 38. However, if the user rating for compatible mobile application 62 does not meet a predefined threshold, application installation process 10 may prohibit 120 the installation of compatible mobile application 62 on mobile device 64 associated with user 38.

Assume for illustrative purposes that the above-described user ratings may be between one and five stars, wherein these user ratings are calculated based upon feedback from users of the mobile applications. For example, if a user downloads a specific mobile application, that user may provide a user rating (between one and five stars) for the specific mobile application they downloaded. Assume for illustrative purposes that the above-described threshold is four stars. Accordingly, application installation process 10 may be configured so that if compatible mobile application 62 has a user rating of four or five stars, application installation process 10 may permit 118 the installation of compatible mobile application 62 onto mobile device 64. Conversely, application installation process 10 may be configured so that if compatible mobile application 62 has a user rating of three or less stars, application installation process 10 may prohibit 120 the installation of compatible mobile application 62 onto mobile device 64, thus deeming compatible mobile application 62 to be non-compatible.

While the system is described above as installing compatible mobile application 62 onto a single mobile device (e.g., mobile device 64), this is for illustrative purposes only and is not intended to be a limitation of this disclosure, as other configurations are possible and are considered to be within the scope of this disclosure. For example, if user 38 owns multiple mobile devices (e.g., they also own a tablet, not shown), mobile device 64 may be installed onto both devices (e.g., mobile device 64 and the above-referenced tablet, not shown).

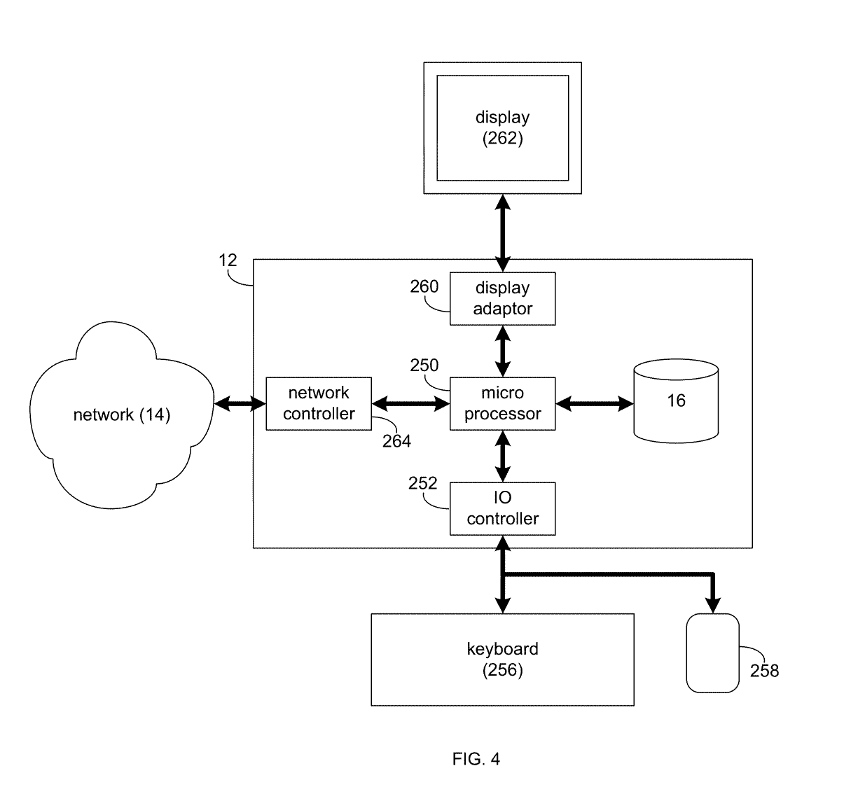

Referring also to FIG. 4, there is shown a diagrammatic view of computing system 12. While computing system 12 is shown in this figure, this is for illustrative purposes only and is not intended to be a limitation of this disclosure, as other configuration are possible. For example, any computing device capable of executing, in whole or in part, application installation process 10 may be substituted for computing device 12 within FIG. 5, examples of which may include but are not limited to client electronic devices 28, 30, 32, 34.

Computing system 12 may include microprocessor 250 configured to e.g., process data and execute instructions/code for application installation process 10. Microprocessor 250 may be coupled to storage device 16. As discussed above, examples of storage device 16 may include but are not limited to: a hard disk drive; a tape drive; an optical drive; a RAID device; an NAS device, a Storage Area Network, a random access memory (RAM); a read-only memory (ROM); and all forms of flash memory storage devices. IO controller 252 may be configured to couple microprocessor 250 with various devices, such as keyboard 256, mouse 258, USB ports (not shown), and printer ports (not shown). Display adaptor 260 may be configured to couple display 262 (e.g., a CRT or LCD monitor) with microprocessor 250, while network adapter 264 (e.g., an Ethernet adapter) may be configured to couple microprocessor 250 to network 14 (e.g., the Internet or a local area network).

As will be appreciated by one skilled in the art, the present disclosure may be embodied as a method (e.g., executing in whole or in part on computing device 12), a system (e.g., computing device 12), or a computer program product (e.g., encoded within storage device 16). Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium (e.g., storage device 16) having computer-usable program code embodied in the medium.

Any suitable computer usable or computer readable medium (e.g., storage device 16) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor (e.g., processor 250) of a general purpose computer/special purpose computer/other programmable data processing apparatus (e.g., computing device 12), such that the instructions, which execute via the processor (e.g., processor 250) of the computer or other programmable data processing apparatus, create means for implementing the functions/acts specified in the flowchart and/or block diagram block or blocks.

These computer program instructions may also be stored in a computer-readable memory (e.g., storage device 16) that may direct a computer (e.g., computing device 12) or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer (e.g., computing device 12) or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Having thus described the disclosure of the present application in detail and by reference to embodiments thereof, it will be apparent that modifications and variations are possible without departing from the scope of the disclosure defined in the appended claims.

1. A computer-implemented method comprising:
receiving a notification from a first website of a user signing into the first website, wherein the user signed into the first website using credentials from a second website;
determining if a compatible mobile application is available for the first website, wherein the compatible mobile application is configured to interface with the first website and provide functionality of the first website;
if a compatible mobile application is available for the first website, determining if the user has the compatible mobile application installed on a mobile device associated with the user; and
if the user does not have the compatible mobile application installed on the mobile device associated with the user, determining if the compatible mobile application may be installed on the mobile device associated with the user,
if the compatible mobile application may be installed, installing the compatible mobile application on the mobile device associated with the user, configuring the compatible mobile application to sign in using credential from the second website.

2. A computer-implemented method comprising:
receiving a notification from a first website of a user signing into the first website;
determining if a compatible mobile application is available for the first website, wherein the compatible mobile application is configured to interface with the first website and provide functionality of the first website;
if a compatible mobile application is available for the first website, determining if the user has the compatible mobile application installed on a mobile device associated with the user; and
if the user does not have the compatible mobile application installed on the mobile device associated with the user, determining if the compatible mobile application may be installed on the mobile device associated with the user.

3. The computer-implemented method of claim 2 wherein the user signed into the first website using credentials from a second website.

4. The computer-implemented method of claim 3 wherein the second website is a social networking website.

5. The computer-implemented method of claim 2 further comprising:
if the compatible mobile application may be installed, installing the compatible mobile application on the mobile device associated with the user.

6. The computer-implemented method of claim 5 wherein installing the mobile application on the mobile device associated with the user includes:
configuring the compatible mobile application to sign in using credentials from a second website.

7. The computer-implemented method of claim 2 wherein determining if a compatible mobile application is available for the first website includes:
determining a device type for the mobile device associated with the user.

8. The computer-implemented method of claim 7 wherein determining if a compatible mobile application is available for the first website further includes:
determining if the compatible mobile application is available for the device type.

9. The computer-implemented method of claim 2 wherein determining if a compatible mobile application is available for the first website includes:
determining a user rating for the compatible mobile application.

10. The computer-implemented method of claim 9 wherein determining if a compatible mobile application is available for the first website further includes:
if the user rating meets a predefined threshold, permitting the installation of the compatible mobile application on the mobile device associated with the user.

11. The computer-implemented method of claim 9 wherein determining if a compatible mobile application is available for the first website further includes:
if the user rating does not meet a predefined threshold, prohibiting the installation of the compatible mobile application on the mobile device associated with the user.

12. A computing system including at least one processor and at least one memory architecture coupled with the at least one processor, wherein the computing system is configured to perform operations comprising:
receiving a notification from a first website of a user signing into the first website;
determining if a compatible mobile application is available for the first website, wherein the compatible mobile application is configured to interface with the first website and provide functionality of the first website;
if a compatible mobile application is available for the first website, determining if the user has the compatible mobile application installed on a mobile device associated with the user; and
if the user does not have the compatible mobile application installed on the mobile device associated with the user, determining if the compatible mobile application may be installed on the mobile device associated with the user.

13. The computing system of claim 12 wherein the user signed into the first website using credentials from a second website.

14. The computing system of claim 13 wherein the second website is a social networking website.

15. The computing system of claim 12 further comprising:
if the compatible mobile application may be installed, installing the compatible mobile application on the mobile device associated with the user.

16. The computing system of claim 15 wherein installing the mobile application on the mobile device associated with the user includes:
configuring the compatible mobile application to sign in using credentials from a second website.

17. The computing system of claim 12 wherein determining if a compatible mobile application is available for the first website includes:
determining a device type for the mobile device associated with the user.

18. The computing system of claim 17 wherein determining if a compatible mobile application is available for the first website further includes:
determining if the compatible mobile application is available for the device type.

19. The computing system of claim 12 wherein determining if a compatible mobile application is available for the first website includes:
determining a user rating for the compatible mobile application.

20. The computing system of claim 19 wherein determining if a compatible mobile application is available for the first website further includes:
if the user rating meets a predefined threshold, permitting the installation of the compatible mobile application on the mobile device associated with the user.

21. The computing system of claim 19 wherein determining if a compatible mobile application is available for the first website further includes:
if the user rating does not meet a predefined threshold, prohibiting the installation of the compatible mobile application on the mobile device associated with the user.
